(19) United States
(12) Patent Application Publication
(10) Pub. No.: US 2004/0205698 A1
(43) Pub. Date: Oct. 14, 2004

(54) System and method for event driven programming

(76) Inventors: Barry Edward Schliesmann, Kenilworth, IL (US); Christopher William Weiland, Evanston, IL (US); Timothy Wise, Chicago, IL (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/034,129

(22) Filed: Dec. 28, 2001

Related U.S. Application Data
(60) Provisional application No. 60/258,745, filed on Dec. 29, 2000.

(51) Int. Cl. G06F 9/46

(52) U.S. Cl. 717/106; 719/318

(57) ABSTRACT

A system and method for actively alerting the viewer of any television program to the occurrence of one or more content-based events previously specified as desired by the user that occur in other programs and giving that user the opportunity to tune to, record or perform other functions with those programs. The system integrates data obtained from a data feed with corresponding electronic program data to generate content-based events that the user is alerted to, based on his or her preferences.

### CROSS-REFERENCE TO RELATED APPLICATIONS

This application claims the benefit of U.S. Provisional Application No. 60/258,745 filed Dec. 29, 2000 which is incorporated herein by reference.

### BACKGROUND

Interactive television systems are beginning to take foothold in the worldwide marketplace in a variety of forms (on cable systems, satellite television systems, broadband connectivity to PCs, etc). There are many technology vendors building solutions that allow service providers to marry data and interactive services with video programming. Most of these efforts, however, focus on interactively enabling a specific program (content-based interactivity). In some cases, focus is on the creation of destinations that provide specific information to the user (such as a news or sports portal), or on providing pre-defined information about programs and their timing (electronic or interactive program guides).

Enhanced electronic or interactive program guides typically provide a destination where the user can view, sort and select programming. Many allow the user to select a specific program for later viewing. The program guide then notifies the user when the program is about to start or has started and allows for the user to retune the device (set top box, satellite receiver, etc.) to the selected program.

A user who is interested in the programming on multiple channels currently has to flip back and forth between the channels to see what is interesting, or use picture-in-picture (PIP) capabilities to watch two programs simultaneously. Most PIP systems only allow a user to display a single alternate program. This is limiting since the user may be interested in programming on many channels. Having the PIP screen continuously overlaid over the user's primary programming can impair the enjoyment of the program. PIP screens, for example, can obstruct the user's ability to view a section of a field or court being displayed. This may be acceptable for the moments when the programming on the PIP screen is more compelling than the primary program, but otherwise it proves bothersome. Also, PIP screens require the user to focus on two simultaneous programs at once. As such, the user ends up not enjoying the full “experience” of either program. Flipping back and forth between programs invariably leads to the user missing content of interest.

Accordingly, there is a need for a system that notifies users of specific content-based events occurring on other programs and allows the user and/or user device to automatically retune or additionally tune (e.g., PIP) to the other program.

### SUMMARY

The present invention provides a system and method capable of notifying the user of a content-based event in another program. A content-based event can be described as a one which occurs in a program that is distributed over a broadcast network (such as when a specific team scores in a broadcast sporting event or when a stock hits a new low and it is being discussed on a broadcast television program).

### BRIEF DESCRIPTION OF THE DRAWINGS

These and other features, aspects, and advantages of the present invention will become better understood with regard to the following description, appended claims, and accompanying drawings where:

FIG. 1 depicts an overview of the event driven programming system;

FIG. 2 is an exemplary “schedule message”;

FIG. 3 is an exemplary “content-related message”;

FIG. 4 depicts an example of a user alert selection interface;

FIG. 5 is an exemplary program descriptor;

FIG. 6 is an exemplary feed processing system generated event message;

FIG. 7 is an exemplary concatenated content-based event message;

FIG. 8 is a flow chart of the operation of an embodiment of the event to program mapping logic;

FIG. 9 is a flow chart of the operation of an embodiment of the event data assessor logic; and

FIG. 10 depicts an example of an alert notification interface.

### DETAILED DESCRIPTION OF THE INVENTION

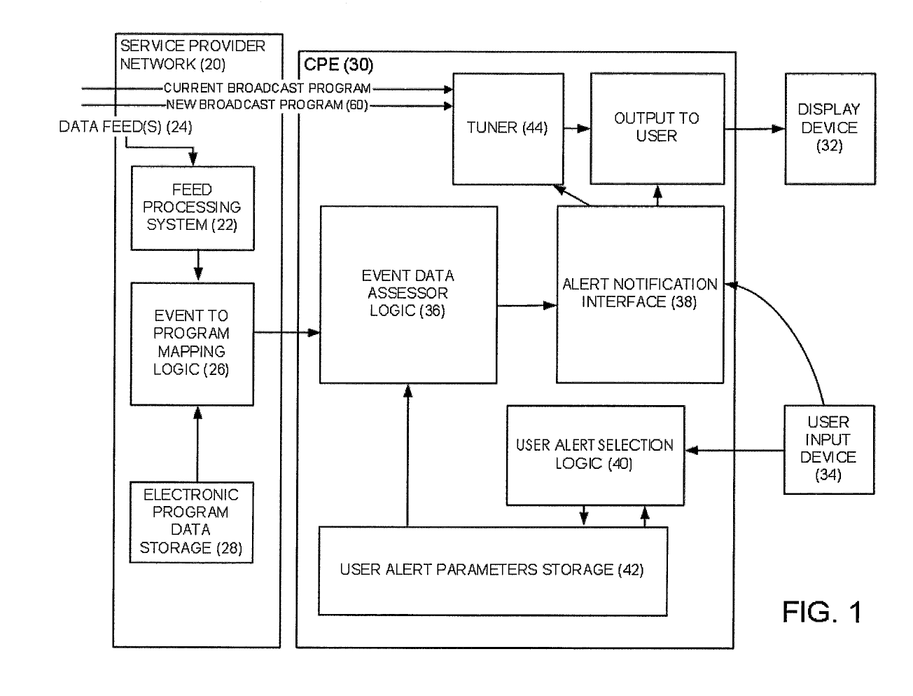

Referring to FIG. 1, in an embodiment of the present invention, the system includes a service provider network 20 having a feed processing system 22 which receives data feeds 24, an event to programming mapping logic component 26 and an electronic program data storage component 28. The system may also include some form of customer premise equipment (CPE) 30 (e.g., a digital or analog tunable device such as a television, a set top box, a DSS receiver, a radio, an internet radio, a personal computer, a satellite receiver, etc.) which may interact with a display device 32 and a user input device 34 (remote control, keyboard, etc.). The customer premise equipment 30 may include an event data assessor logic component 36, an alert notification interface component 38, a user alert selection logic component 40, a user alert parameter storage component 42 and a tuner 44.

As described in detail below, the system allows the user to define his or her own programming by setting content-based event occurrence criteria that will trigger the system to notify the user of the occurrence of the specified content-based events and give him or her several options of what to do at that point, such as a) re-tune the device to the channel of the program where the content-based event has occurred (or is about to occur); b) save the program for a specified period of time to a personal recording device (such as a digital video recorder) and/or c) continue with the currently tuned program. Examples of such content-based events are:

When a specific football team gets within the 20 yard line on offense.

When a specific basketball game gets within a specified point differential.

When a lead change occurs in a sporting event.

When a specific player is at bat in a baseball game.

When the last two minutes are about to begin or have begun in a football game or a final hockey period.

Further, the present invention is not limited for use with just sporting events. It may be used with any appropriate type of programming (e.g., financial market or stock information, etc.)

In operation, the feed processing system 22 of the service provider network 20 is continually receiving data feeds 24 and processing them. The data feeds 24 may be in any format (e.g., XML, tab delimited data, etc.). Such data format is usually set by the data feed provider. As the feed processing system 22 receives the data feeds 24, it parses out the feed data contained in the data stream. This parsed data is usually used by a single broadcast company to provide real-time information to its viewers and is usually made a part of the actual broadcast video signal, or is communicated via voice in audio broadcasts. For instance, broadcasters such as ESPN, FoxSports or CBS SportsLine use this feed data to provide their viewing audiences with real-time information (e.g., sports information, breaking news, weather information, financial data, etc.). The intent behind providing such real-time information, in these situations, is that these broadcasters do not want their viewers moving off of their broadcasted programming or jumping around to other channels to get this real-time information. They want the viewer to stay fixed on a single channel. This is not the intent of the system and method of the present invention, however. To the contrary, the present invention provides the user with a means to facilitate moving between different channels and actually encourages such channel jumping.

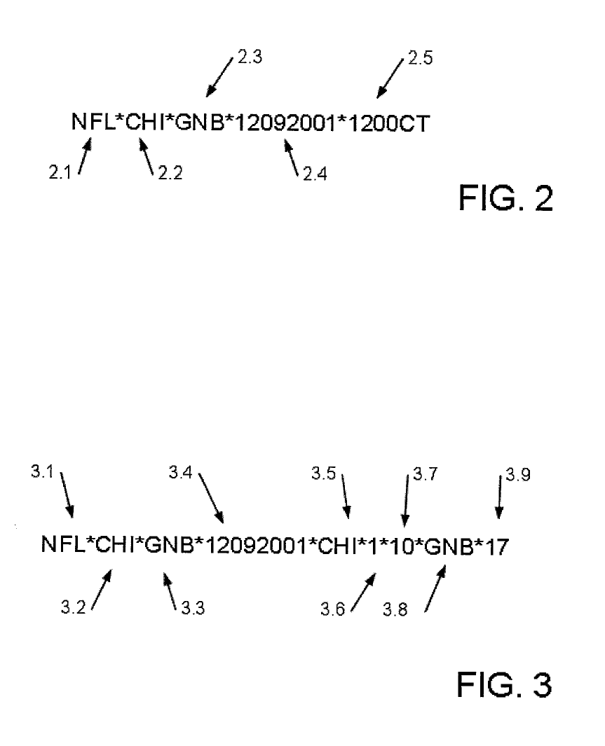

The data feeds 24 received by the feed processing system 22 typically contain several different message types, such as “schedule messages” and “content-related messages”. “Schedule messages” typically provide scheduling information/data about an upcoming program, and “content-related messages” provide specific, real-time information/data about events or situations occurring in those scheduled programs. FIGS. 2 and 3 depict an example “schedule message” and an example “content-related message”, respectively, for an NFL football game. Referring to FIG. 2, in this “schedule message” example, the first code 2.1 indicates the sport or league; the second code 2.2 indicates the visiting team; the third code 2.3 indicates the home team; the fourth code 2.4 indicates the date of the game and the fifth code 2.5 indicates the time of the game. So for this example, the schedule message indicates that there is a scheduled NFL game between the Chicago Bears (visiting team) and the Green Bay Packers (home team) to take place on Dec. 9th, 2001, at 12:00 PM Central Time. This type of message may be available hours, days or even weeks before the actual game. The combination of the codes (i.e., the league code 2.1, the visiting team code 2.2, the home team code 2.3, the date code 2.4 and the time code 2.5) uniquely identifies this game in relation to all other scheduled games. The feed processing system 22 may take this unique data and generate and store a unique identifier to represent this game.

Referring to FIG. 3, in this “content-related message” example, the first four codes 3.1-3.4, as with the first four codes of the “schedule message”, indicate the sport or league (3.1); the visiting team (3.2); the home team (3.3) and the date of the game (3.4). The additional codes of this message (3.5-3.9 in this example) provide specific information about events occurring in the program identified by the first four codes 3.1-3.4. The time code of the scheduled program is no longer provided, as in the “schedule message”, because, when these “content-related messages” are sent, the game is already in progress and the starting time of the game is no longer important. The additional codes in this example 3.5-3.9 specify, for a specific point in the game, which team is on offense 3.5, the down 3.6, the distance to a first down 3.7, which team's side of the field the ball is on 3.8 and the yard line 3.9.

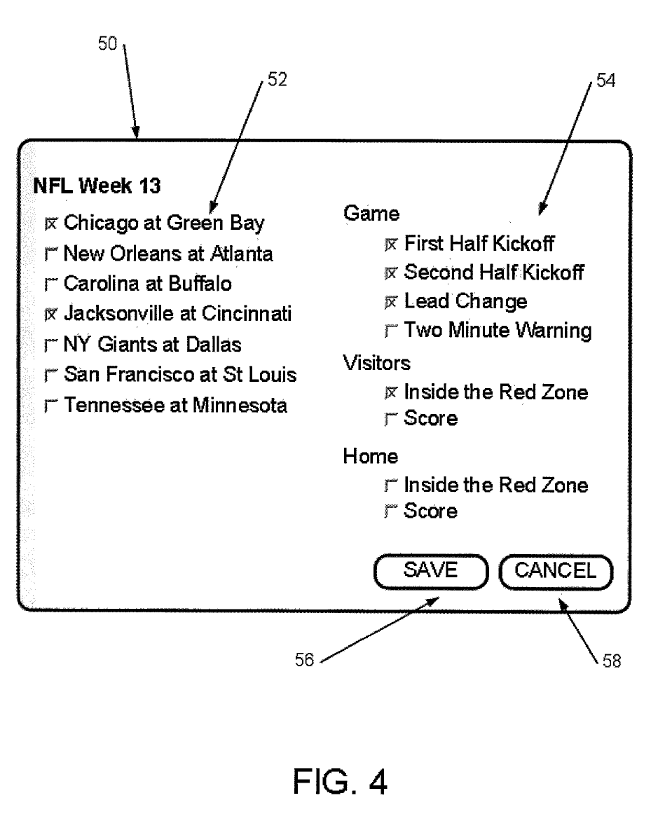

The event to program mapping logic 26 receives parsed data from the feed processing system 22 for potentially every scheduled program and for potentially every event occurring in each scheduled program. The event to program mapping logic 26 is programmed to identify a select set of scheduled programs that will be “enabled” by the system and for those selected programs which events, in turn, will be “enabled”. Referring to FIG. 4, continuing with the NFL example, the event to program mapping logic 26 for Week 13 of the NFL season has been programmed to select certain games to be “enabled” (i.e., Chicago at Green Bay; New Orleans at Atlanta; Carolina at Buffalo; etc.) and has been programmed to select certain events within the “enabled” games to be “enabled” (i.e., First Half Kickoff; Second Half Kickoff; Lead Change; Two Minute Warning, Inside the Red Zone, etc.). (It should be understood that the event to program mapping logic 26 may be programmed to “enabled” any number of scheduled programs. The seven games shown are only by way of example. The event to program mapping logic 26 could be programmed to “enabled” an entire season of NFL games if that was desired.)

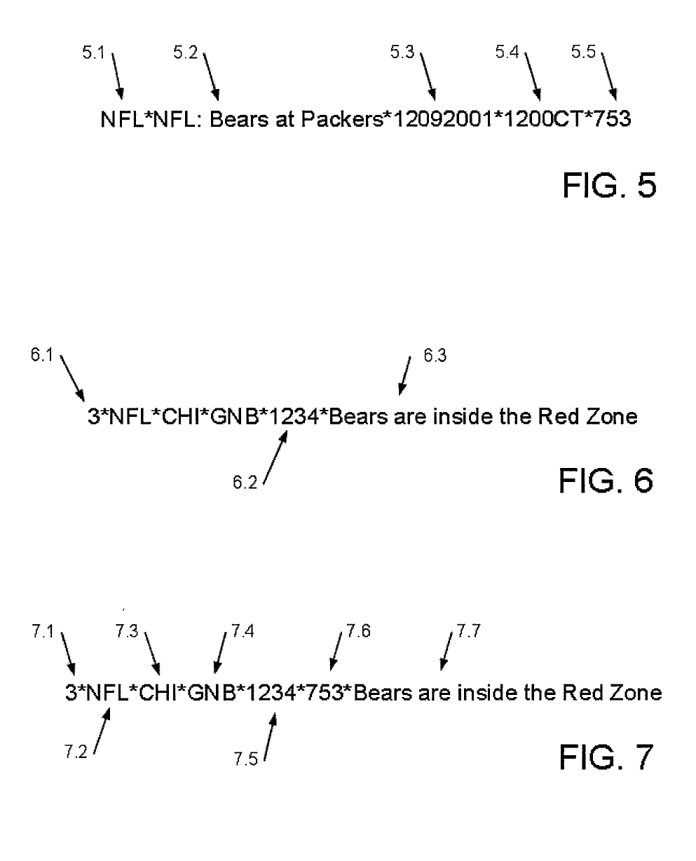

With the scheduled programs and events to be “enabled” programmed into the event to program mapping logic 26, the event to program mapping logic 26 uses the data feed information from feed processing system 22 to “enable” the selected scheduled programs and events to make them available to the end user. When the event to program mapping logic 26 receives the data for a “schedule message” for a program to be “enabled”, the event to program mapping logic 26 maps the raw data to a specific channel using the information in the electronic program data storage 28. The electronic program data storage 28 is a device that contains non-real-time data about a program that is to be provided by the service provider network 20. Such information usually includes the name of the program; the time of the program; a brief, static description of the program and a channel identifier. This information may be self-supplied to the service provider network 20 by the network service provider or it may use an interactive program guide (“IPG”) service such as the ones provided by Gemstar-TV Guide International. Although such data services are labeled interactive, they are only interactive in the sense that the viewer can click on a pre-constructed show description to select that show for viewing. The information contained in these program descriptions is static and preconceived. Referring to FIG. 5, an example of an electronic program data storage program descriptor is depicted. The first code 5.1 indicates the sport or league; the second portion 5.2 is a string describing the program; the third code 5.3 indicates the date of the program; the fourth code 5.4 indicates the time of the broadcast and the fifth code 5.5 indicates the channel that the program will be broadcast on. In this example, the program descriptor indicates that the scheduled NFL game (Bears at Packers) will be broadcast on the television channel corresponding to code “753” on Dec. 9th, 2001, at 12:00 PM Central Time.

To map feed data, the event to program mapping logic 26 runs logic on a periodic basis (e.g., daily, hourly, etc.) and maps specific feed data to a specific program channel. Specifically, the event to program mapping logic 26 compares the sport/league codes of the “schedule message” data (2.1) with the program descriptor (5.1), the program guide's date and time (codes 5.3 and 5.4) to the “schedule message” data date and time (codes 2.4 and 2.5), and the team names or codes (codes 2.2 and 2.3) from the “schedule message” data to the program description (5.2) to obtain the broadcast channel number for the program of interest. This search is facilitated by using conventions employed by IPG's in their program descriptions. It may also be facilitated by using APIs if available. From this search, the event to program mapping logic 26 determines that the Chicago Bears v. Green Bay Packers game will be on the channel corresponding to code “753” for the Dec. 9th, 2001 game. The event to program mapping logic 26 uses that information and the event identifier from the feed processing system 22 to, as described below, link all follow on data feed information about the Bears v. Packers game to that “enabled” program (e.g., the Bears v. Packers game being shown on the channel corresponding to code “753”).

With the data feed information now linked to a specific program, the program is now “enabled” and available to a system user. Referring again to FIG. 4, the system allows the user to choose select “enabled” events from a list of available programs. Typically, this set of “enabled” content-based events is determined by a combination of several factors, including: a) what content-based events can be extracted/synthesized from the data in the data feed; b) which of these events makes sense in an interactive television (ITV) context and c) which of these events the system administrator wishes to enable to its customers. For example, a data feed might provide sufficient information for football games such that the feed processing system 22 can determine from the data feed that the home team has possession of the ball and the ball is positioned within the opponent's 20 yard line. This feed data can be used to generate a content-based event that indicates that the home team has entered the “red zone”—a content-based event which is interesting to potential viewers of football games, and one that makes sense in an ITV context. Thus, the system is configured by the system administrator such that this particular content-based event is “enabled” on the system. During this process, the enabled event is assigned a unique event identifier; in this case, the event is “home team inside the red zone.” Some examples of other enabled events for football might be: “first half kickoff”, “lead change”, “home team has scored”, “visiting team has scored” and “two minute warning”.

This enabling configuration process is performed once for each content-based event that can be derived from the data feed by the feed processing system. Once a content-based event is enabled, the event to program mapping logic 26 will then make that event available for selection by the user during alert selection, and in the future, as described below, will pass it on to the event data assessor logic 36 for comparison to the user's preferences whenever the content-based event occurs within a football game, as received from the data feed via the feed processing system 22.

The event data assessor logic 36 generates an interface containing user alert selection logic 40 on the display device 32 that the user can interact with. FIG. 4 depicts an example interface 50. The left-hand side of the screen in this example lists all of the available programs 52 (NFL Week 13). The user in this example has selected two games (Chicago at Green Bay and Jacksonville at Cincinnati). Following the user alert selection logic 40, the user chooses what specific content-based events or general event types that they want to be alerted about. In the example depicted in FIG. 4, the available events 54 are listed on the right-hand side of the screen, and the user has selected the following events for alert notification: for the Game, “First Half Kickoff”, “Second Half Kickoff” and “Lead Change”; for Visiting Team's events, “Inside the Red Zone” and no events for the Home Team. In this embodiment, to save these selections, the user selects the “Save” button 56, and these preferences are stored in the user parameter alert storage 42. In this embodiment, if the user wants to cancel these selections, the user selects the “Cancel” button 58. The user parameter alert storage 42 is depicted as being part of the customer premise equipment 30, but it may be located anywhere in the system, such as on the service provider network 20. Also, previously saved user preferences and parameters may be retrieved for addition, modification or deletion if desired.

The event to program mapping logic 26 is continually mapping data from the feed processing system 22 to channels based on the information in the electronic program storage data storage 28. There are a number of ways that the event to program mapping logic 26 may receive data from the feed processing system 22. A preferred way would be to use APIs, but as most feed processing systems 22 are presently configured for a specific purpose, they do not have commonly available APIs. Therefore, two possible methods for the feed processing system 22 and the event to program mapping logic 26 to interface is; (1) to utilize a message queuing mechanism where as the feed data comes in to the service provider network 20 it is immediately and asynchronously delivered to the event to program mapping logic 26 for processing or (2) to poll the feed processing system 22 periodically. The polling system is less desirable since the polling interval would need to be very small (i.e., less than 10 seconds) in order to deliver the appropriate message to the user in a timely manner. The event to programming mapping logic 26 and the feed processing system 22 are tightly integrated because in most cases the event to programming mapping logic's ability to map content-based events to specific programming channels will be based upon game or program identifiers supplied by the feed processing system 22. Creation of game or program identifiers is typically the responsibility of the feed processing system and/or the feed provider.

With the selected programs and events “enabled”, the system now sends alerts, as appropriate, using the “content-related message” information received by the feed processing system 22. The feed processing system 22 uses the information from an incoming “content-related message” to retrieve the unique program identifier for this program previously assigned during the processing of the “schedule message” described above. As depicted in FIG. 6, in this embodiment, the feed processing system 22 then adds to the event message a code identifying the specific event 6.1, the unique game identifier 6.2, and the alert message string 6.3 that may eventually be displayed to the user, and makes this content-based event message available to the event to program mapping logic 26. The alert message string, in this example, is generated by the feed processing system 22 using sport-specific rules and logic programmed into the system that interpret and process the data from the feed messages and which may include other pre-programmed data such as team code-to-team name translations.

As the event to programming logic 26 receives messages from the feed processing system 22, it looks to see if it has previously obtained a broadcast channel that corresponds to the message by querying for a channel number stored against the unique game identifier. If no match is found, the event to programming logic 26 queries the electronic program data storage 28 to attempt to obtain a corresponding channel number, as described above. If no match is found in this instance, the message is discarded. If a match is found, a concatenated content-based event message is generated for delivery to the event data assessor logic 36 in the customer premise equipment. FIG. 7 provides an example of such a concatenated content-based event message. This message contains the event identifier code 7.1, sport/league code 7.2, visiting team code 7.3, home team code 7.4, unique game identifier 7.5, channel number code 7.6 and alert message string 7.7.

The event data assessor logic 36 receives the concatenated event object and determines if the content-based event is of interest to the user by evaluating the user stored parameters 42. If there is no match, the concatenated event object may be discarded. If there is a match, the event data assessor logic passes the event object to the alert notification interface 38. The alert notification interface 38 indicates to the user that the content-based event of interest has or is about to occur, and can prompt the user to determine what to do. In one embodiment, this would be done in the form of a limited intrusion overlay similar to how program information and notifications are displayed by existing Enhanced Program Guides. Using the above Bears versus Packers example, the alert notification interface 38 would state “The Bears have just entered the red zone against the Packers. Do you want to watch that program?” The user could then utilize the user input device 34 to select “Watch,” “Ignore,” or could take other actions depending on the specific embodiment such as “Record for later viewing.” If the user selects “Ignore,” the overlay display presented by the alert notification interface 38 would cease and the user would resume watching the current program. If the user selects “Watch,” the alert notification interface 38 would direct the tuner 44 to retune to the channel specified in the concatenated event object. The tuner 44 would change the signal to the display device 32 to deliver the contents of the new broadcast signal 60 which correlates to the channel information in the concatenated event object.

The event to program mapping logic 26 also has an understanding of the types of content-based events specifiable for notification by the user. Though the event to program mapping logic 26 has the ability to concatenate every piece of data to a channel, it is foreseeable that network service providers will only want predetermined content-based events mapped and passed to the event data assessor logic 36. For example, even though the feed processing system distributes information about every pitch in a baseball game, logic that allows the user to select “every time there is a strike in the Cubs versus Brewers game” is not likely to be acceptable to network service providers. It is assumed that specific embodiments of this invention with specific service providers will have unique predetermined event types about which the user can be notified. This allows for minimization of the number of concatenated event objects that would be distributed over the network. How the content-based event objects are distributed to the customer's premise equipment in the service provider network is highly dependent on the network topology and relies on well known methods. Many delivery mechanisms are common such as embedding data in the vertical blanking interval in analog systems, embedding data in digital video streams (hardware and software solutions for this are readily available) or the use of out-of-band channels such as solutions where a cable modem is resident in the customer premise equipment 30. The variations in implementations of this invention are dependent on the specific technologies utilized by the service provider. For example, the general embodiment example shown in FIG. 1 represents the user alert parameters storage 42 and the programs that interface with it (the event data assessor logic 36 and the user alert selection logic 40) as residing on the customer premise equipment 30. The amount of available memory, storage and processing power available on specific customer premise equipment 30 embodiments will determine the location of those logical elements.

An example specific embodiment of this invention is described for implementation in a two-way DOCSIS cable modem environment with customer premise equipment 30 that is capable of storing user-specified preference information locally on the equipment. In a two-way environment, data may be requested by the customer premise equipment 30, either programmatically or by user interaction.

For this embodiment, the customer premise equipment assumes a DOCSIS-enabled digital set-top box with a remote control, connected to a television. The set-top box provides a tuner; a web browser which supports HTML, JavaScript, frames, persistent cookies; the ability to display HTML data as an overlay on a television signal; the ability to instruct the tuner to tune to a specific channel; and the ability to communicate bi-directionally with a web/application server at the cable head-end.

The user alert selection logic interface 38 is implemented as a set of one or more web pages served by a web/application server at the cable head-end (or a server connected to it), which retrieves the set of possible content-based event categories from a data store at the head-end. FIG. 4 depicts an example of the user alert selection interface 38 implemented as a web page displayed by the set-top box browser on the interface 50. This example interface is configured to enable the user to select from a list of upcoming NFL football games 52 for which content-based event types 54 are available. Before displaying the interface, the alert selection logic 40 sets up any existing preferences stored in an associated persistent cookie. If the user selects the “Save” button 56 with the user input device 34, the user's selections are saved in the persistent cookie, and the interface is removed. If the user selects the “Cancel” button 58, the new selections are not saved and the interface is removed.

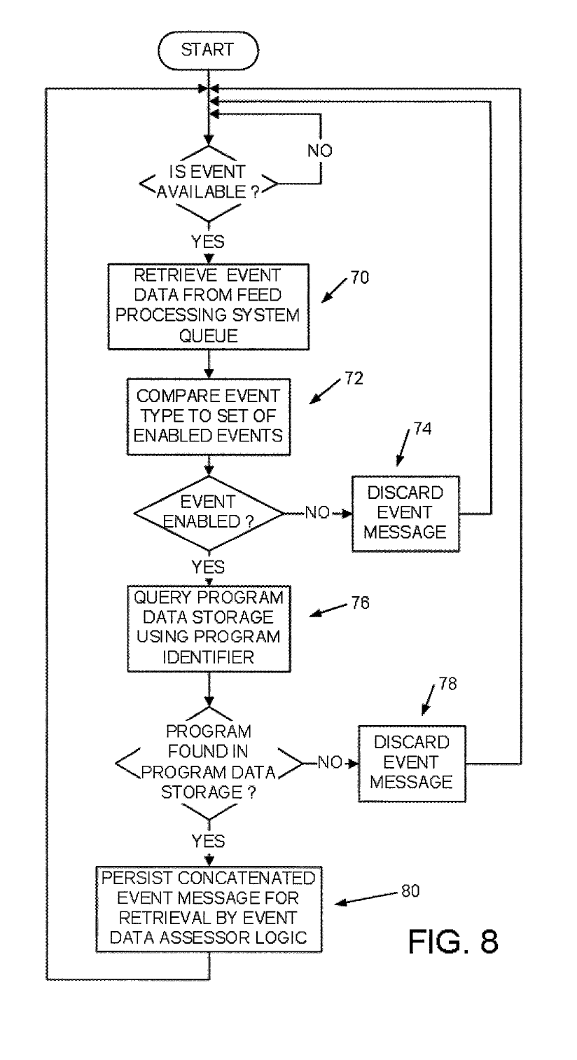

The feed processing system 22 and event to program mapping logic 26 are implemented on a server at the cable head-end premises (or connected to it). FIG. 8 illustrates the operation of an example event to program mapping logic 26 process. The feed processing system 22 continually receives data from the data feed(s) 24, generates content-based events from this data, and places these events in a queue. The event to program mapping logic 26 retrieves these content-based events from the queue 70. This logic then compares the content-based event to the set of enabled events 72. If the content-based event is not enabled, the event is discarded and the next content-based event is retrieved from the queue 74. If the content-based event is enabled, the event to program mapping logic 26, then queries the electronic program data storage 28 using a program identifier stored in the content-based event in order to obtain the channel on which the program is broadcast 76. If no such channel exists, the content-based event is discarded 78 and the next content-based event (if any) is pulled from the queue. If a channel exists that corresponds to the content-based event's program, a concatenated event message is created. In this embodiment, this message contains the program's channel number; the content-based event's categorization information (league and team codes, the specific event code); and the text message describing the event that is to be displayed to the user by the alert notification interface 38 on the set-top box. This concatenated event message is then persisted and made accessible via the web/application server such that the event data assessor logic 36 on the set-top box may retrieve it 80.

The event data assessor logic 36 and alert notification interface 38 are implemented as part of an interactive HTML application served by the web/application server at the head-end and running in the web browser system on the set-top box. This application is implemented as a frameset containing a full-screen frame with a television display element and an alert display layer whose visibility is controlled via JavaScript. The application is launched in a manner consistent with the set-top box's interactive environment.

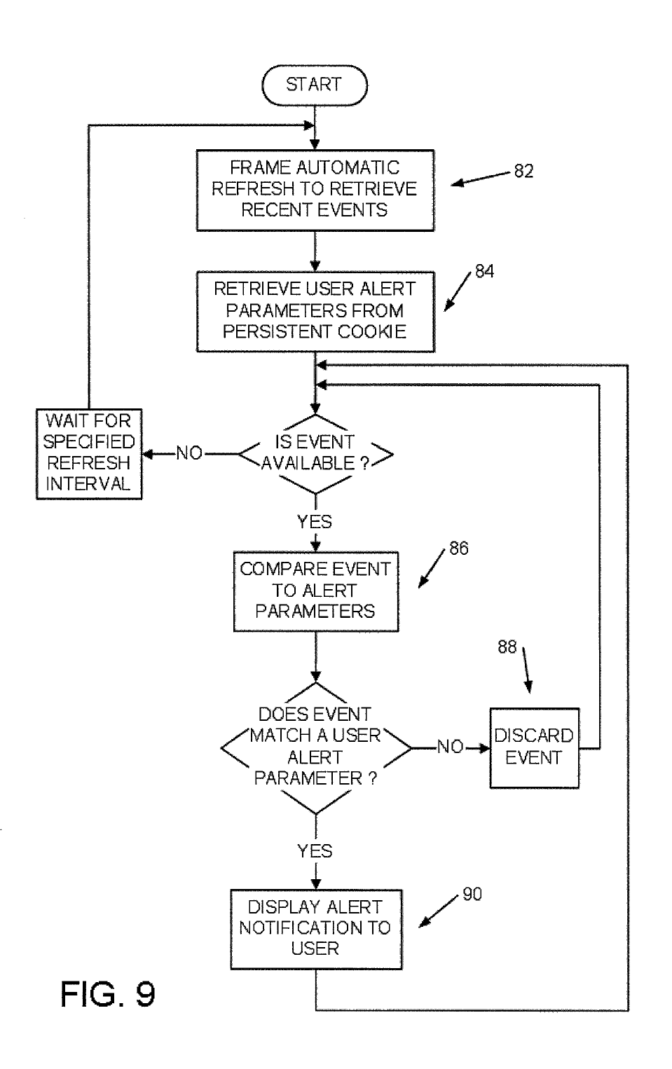

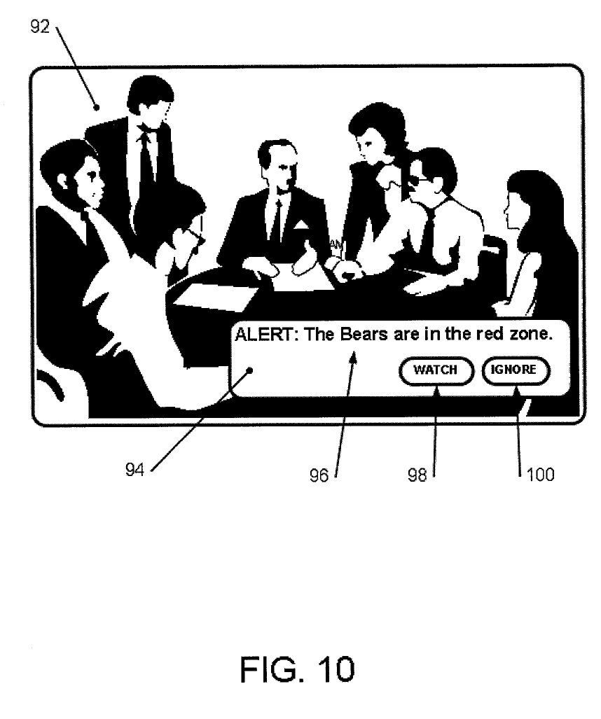

The event data assessor logic 36 is implemented on the set-top box in JavaScript using a hidden frame within the user application's frameset. FIG. 9 depicts an exemplary operation of the event data assessor logic 36. This frame refreshes itself on a periodic basis (once every 15 seconds, for example) 82, thus retrieving any pending event messages from the web/application server at the head-end. JavaScript in this frame then retrieves the user's parameters from a persistent cookie 84. The JavaScript in this frame then compares each event message in turn to the user's preferences 86. If the content-based event does not match a user preference, the content-based event is discarded and the next message is processed 88. If the event message represents an content-based event for which the user has specified a preference 90, the alert notification interface 38 formats the content of the hidden alert display layer to contain the event message's text, as well as an interface element (e.g., a button) configured to instruct the set-top box to tune to the channel presenting the program to which the content-based event applies, and an interface element (e.g., another button) that will dismiss the content-based event should the user choose not to watch the content-based event's program. The alert notification interface 38 then makes the hidden alert layer visible to the user. FIG. 10 depicts a television screen 92 displaying a program, with the visible alert 94 displaying the event message's text 96. The user selects an action using the set-top box's input device to activate one of the alert's buttons. If the user clicks the “watch” button 98, the set-top box tunes to the channel that displays the program associated with the content-based event. If the user clicks the “ignore” button 100, the application hides the alert layer and the user continues to watch the current program.

While the invention has been discussed in terms of preferred and specific embodiments, it should be appreciated by those of skill in the art that the invention is not so limited. The embodiments are explained herein by way of example, and there are numerous modifications, variations and other embodiments that may be employed that would still be within the scope of the present invention.

What is claimed is:

1. A system for generating alerts to events in a program not currently being viewed comprising:
a user preference application for capturing information on which programs a user wants to monitor and what events a user wants to be alerted to;
a data feed containing event information about the programs selected for monitoring; and
an alert generation application which compares the data feed event information to the captured user preferences and generates an alert for the user for each event that matches a captured user preference.

2. The system of claim 1 further comprising:
an electronic program guide having viewing channel information; and
a mapping application which maps the data feed event information to a specific viewing channel.

3. The system of claim 2 further comprising, an alert generation and tuning application which compares the mapped event information to the captured user preferences, generates an alert for the user for each event that matches a captured user preference and provides a mechanism for the user to tune to the program which the alert concerned.

4. The system of claim 3 wherein the provided mechanism for tuning is a generated user interface which provides a prompt allowing the user to tune to the program which the alert concerned.

5. The system of claim 3 wherein the provided mechanism for tuning is a generated user interface which provides a prompt allowing the user to record the program which the alert concerned.

6. The system of claim 3 wherein the provided mechanism for tuning is a generated user interface which provides a prompt allowing the user to view the program which the alert concerned in a picture-in-picture display.

7. The system of claim 1 wherein the captured user preference information is stored to a persistent storage device.

8. The system of claim 1 wherein the data feed contains event information about a sports program.

9. The system of claim 1 wherein the data feed contains event information about the financial markets.

10. A system for generating alerts to events in a program not currently being viewed comprising:
a user preference application for capturing information on which programs a user wants to monitor and what events a user wants to be alerted to;
a data feed containing event information about the programs selected for monitoring;
a mapping application which maps the data feed event information to a viewing channel; and
an alert generation and tuning application which compares the mapped event information to the captured user preferences, generates an alert for the user for each event that matches a captured user preference and provides a mechanism for the user to tune to the program which the alert concerned.

11. The system of claim 10 wherein the provided mechanism for tuning is a generated user interface which provides a prompt allowing the user to tune to the program which the alert concerned.

12. The system of claim 10 wherein the provided mechanism for tuning is a generated user interface which provides a prompt allowing the user to record the program which the alert concerned.

13. The system of claim 10 wherein the provided mechanism for tuning is a generated user interface which provides a prompt allowing the user to view the program which the alert concerned in a picture-in-picture display.

14. The system of claim 10 wherein the captured user preference information is stored to a persistent storage device.

15. The system of claim 10 wherein the data feed contains event information about a sports program.

16. The system of claim 10 wherein the data feed contains event information about the financial markets.

17. A system for generating alerts to events in a program not currently being viewed comprising:
means for capturing information on which programs a user wants to monitor and what events a user wants to be alerted to;
a data feed containing event information about the programs selected for monitoring;
means for mapping data feed event information to a viewing channel; and
means for alert generation and tuning which compares the mapped event information to the captured user preferences, generates an alert for the user for each event that matches a captured user preference and provides a means for the user to tune to the program which the alert concerned.

18. A system for automatically mapping data feed information to a specific viewing channel comprising:
a data feed containing at least one program identifier;
an electronic program guide having at least one program identifier and program viewing channel information; and
a mapping application which automatically compares the data feed program identifier information with the program guide program identifier information and for each data feed and program guide having similar identifiers, maps the data feed to the program guide so that the data feed information is mapped to a specific viewing channel.

19. A method for generating alerts to events in a program not currently being viewed comprising:
capturing information on which programs a user wants to monitor and what events a user wants to be alerted to;
providing a data feed containing event information about the programs selected for monitoring;
mapping data feed event information to a viewing channel;
comparing the mapped event information to the captured user preferences;
generating an alert for the user for each event that matches a captured user preference; and
providing a mechanism for the user to tune to the program which the alert concerned.

20. The method of claim 19 wherein the provided mechanism for tuning is a generated user interface which provides a prompt allowing the user to tune to the program which the alert concerned.
